(19) United States
(12) Patent Application Publication
(10) Pub. No.: US 2017/0290263 A1
(43) Pub. Date: Oct. 12, 2017

(54) Device for Processing Harvested Crops and Method for Controlling the Flow of a Harvested Crop in the Device

(71) Applicant: Hartmut KEMMNER, Beilrode (Orsteil Zwethau) (DE)

(72) Inventor: Hartmut KEMMNER, Beilrode (Orsteil Zwethau) (DE)

(21) Appl. No.: 15/518,098

(22) PCT Filed: Oct. 2, 2015
(86) PCT No.: PCT/EP2015/072779

§ 371 Date: Jun. 9, 2017

(30) Foreign Application Priority Data
Oct. 10, 2014 (DE) 10 2014 114 717.0

(51) Int. Cl. A01D 41/127; A01F 17/02; A01F 15/10; A01D 87/02

(52) U.S. Cl. CPC A01D 41/127; A01D 87/02; A01F 17/02; A01F 15/10; A01D 61/00

(57) ABSTRACT

An apparatus for processing harvested crops, in particular a threshing and/or separating apparatus, comprising a rotor which is mounted rotatably about its longitudinal axis, a separating device with a separating device region which at least partially surrounds a lower circumferential region of the rotor, the circumferential region being arranged below the longitudinal axis in an operationally ready state of the apparatus, and is arranged radially spaced apart from the rotor. A passage region for the harvested crop is formed between the separating device regions and the lower circumferential region of the rotor, wherein the separating device region extends along the longitudinal axis, and comprises at least one control element. The control element is movable into the passage region and/or into an axial projection of the passage, in order to control the flow of harvested crop.

This application claims the priority of German patent application DE 10 2014 114 717.0, filed on Oct. 10, 2014. The entire content of this application is herewith incorporated by reference.

### FIELD

The invention generally relates to an apparatus for processing harvested crops, such as a threshing and/or separating apparatus, comprising a rotor which is mounted rotatably about its longitudinal axis, and a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, and wherein the separating device region extends along the longitudinal axis, at least in a partial region of the rotor.

The invention furthermore generally relates to a combine harvester with an apparatus of the abovementioned type.

Furthermore, the present invention generally relates to a method for controlling the flow of a harvested crop in an apparatus for processing harvested crops, such as a threshing and/or separating apparatus, wherein the apparatus comprises a rotor which is mounted rotatably about its longitudinal axis, and a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, and wherein the separating device region extends along the longitudinal axis, at least in a partial region of the rotor.

### BACKGROUND

For the harvesting of cereals, such as, in particular grain, but also rape, sunflowers, field beans, grass seeds or the like, use is made of what are referred to as combine harvesters. During the harvesting operation, the cereals are first of all cut or picked with a corresponding cutting mechanism or harvesting header. During a subsequent threshing operation, the grains are threshed with the aid of what is referred to as a threshing mechanism and separated from other plant constituents. From the threshing mechanism, the harvested crop passes for separation into what is referred to as a sifting region in which the loose mixture of plant constituents and the remaining grains is further separated by air separation and/or sifting. After a cleaning operation, the grains are conveyed into a grain tank. The remaining plant constituents are separated off and remain, for example, on the field.

The threshing mechanism can be arranged, for example, transversely with respect to a working direction of the combine harvester. Such a threshing mechanism is referred to as a tangential threshing mechanism. The threshing mechanism customarily has a threshing concave in which a threshing drum which is provided with what are referred to as beater bars rotates at a high speed. The threshing drum is arranged at a radial distance from the threshing concave, and therefore a narrow threshing gap is formed between the threshing drum and the threshing concave. The cereals are broken off by abrasion in said threshing gap, thus providing a loose mixture of grains and other plant constituents, the mixture being separated from one another in further working steps.

In a further variant, what is referred to as the axial flow threshing mechanism, at least one rotor is arranged in the working direction of the associated combine harvester. The threshing concave is arranged radially spaced apart from the rotor and at least partially surrounds a lower circumferential region of the rotor. The rotor here is occupied, for example, with diagonally running beater bars. The harvested crop is broken off by abrasion by means of the rotational movements of the rotor. The resistance necessary for this purpose is provided by the separating region between the rotor and the separating device, said separating region surrounding the lower part of the rotor.

In order to regulate the separation in such an apparatus, it is known, for example, to adjust a radial distance between rotor/threshing drum and threshing concave in order to influence the severing of grain and other plant constituents. A disadvantage of this method is that, specifically in the case of harvested crops having a relatively high grain portion and little other plant constituents, increased grain losses occur since the overall mass which is necessary for breaking down the grains by abrasion is too low. Due to the overall mass being too low, the grains are only partially broken off by abrasion, or the separating surfaces of the apparatus are only partially charged with harvested crop. If the threshing gap between the rotor and the threshing concave is greatly reduced in order to reduce the grain losses, this leads to losses in efficiency of the apparatus. In other words, the achievable harvesting efficiency is therefore reduced.

In the case of known threshing or separating apparatuses, increased grain losses and/or losses of efficiency occur in particular at the beginning and at the end of each threshing operation (for example when turning the combine harvester around at the end of the field) since the threshing and/or separating apparatus is virtually completely emptied in this operating situation and therefore the overall mass of the harvested crop is insufficient for efficiently breaking down the grains by abrasion. This problem is reinforced in the case of harvested crops which have very low amounts of plant constituents. As a consequence of the low amounts of plant constituents, the resistance required for efficient breaking down of the grains by abrasion is not built up in the threshing gap.

It is therefore an object of the present application to specify an apparatus for processing harvested crops, which apparatus reduces the grain losses and which substantially does not lead to any losses of efficiency of the apparatus.

It is furthermore an object of the present application to specify a combine harvester with an apparatus of this type.

Furthermore, it is an object of the present application to specify a method for controlling the flow of a harvested crop in an apparatus for processing harvested crops, in which lower grain losses and substantially no losses of efficiency of the apparatus occur.

### BRIEF SUMMARY

According to a first aspect, there is provided an apparatus for processing harvested crops, comprising a rotor which is mounted rotatably about its longitudinal axis, a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, wherein the separating device region extends along the longitudinal axis, at least in a partial region of the rotor, and at least one control element which is arranged on the separating device region, wherein the at least one control element is movable into the passage region and/or into an axial projection of the passage region, said axial projection being formed along the longitudinal axis, in order to control the flow of harvested crop.

According to a second aspect, there is provided a combine harvester which has an apparatus of the abovementioned type.

According to a third aspect, there is provided a method for controlling the flow of a harvested crop in an apparatus for processing harvested crops, wherein the apparatus a rotor which is mounted rotatably about its longitudinal axis, a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, wherein the separating device region extends along the longitudinal axis, at least in a partial region of the rotor, and has at least one control element which is arranged on the separating device region, wherein the method comprises moving the at least one control element into the passage region and/or into an axial projection of the passage region, said axial projection being formed along the longitudinal axis, in order to control the flow of harvested crop.

An axial projection of the passage region is understood here as meaning a region which adjoins the passage region in a flow direction of the harvested crop.

An operationally ready state of the apparatus is understood here as meaning a state in which the apparatus is fitted, for example, in a combine harvester.

“Moving in” is understood here as meaning any sequence of movement. This sequence of movement can in particular change the radial position of the control element. In particular, it can generally involve introducing the control element radially. Moving in can be, for example, a translatory movement for example pushing up or displacement. Moving in can also be a rotatory movement, for example engagement, pivoting and/or a rotational movement. Pivoting can take place about an eccentric axis of the control element. A rotational movement can take place about a central axis or an axis of symmetry of the control movement. Even a combined translatory and rotatory movement is possible. The at least one control element can therefore be pushable, pivotable and/or rotatable in particular into the passage region or into an axial projection of the passage region, said axial projection being formed along the longitudinal axis.

The introducing or moving in of the control element causes the passage region and/or the axial projection of the passage region to be narrowed in the radial direction over an axial length of the control element. By contrast, the general radial distance between the separating apparatus and the rotor (or an axial projection of the rotor) is maintained unchanged. The harvested crop can therefore be braked during passage through the apparatus with the aid of the at least one control element. As a consequence, the overall mass of the harvested crop located in the apparatus is increased. This in turn leads to lower grain losses, in particular in the case of harvested crops with a high grain portion and low amount of other plant constituents. Furthermore, the losses of efficiency of the apparatus can be minimized because of the unchanged general distance between the separating apparatus and the rotor.

In a preferred refinement, the lower circumferential region covers an angular region of 180°, preferably 160°, which is arranged below the longitudinal axis.

Introducing or moving the at least one control element into the region arranged below the longitudinal axis makes it possible in particular for harvested crop with a high grain portion to be subjected to an effective severing operation. Even in operating situations in which the apparatus is virtually completely emptied of harvested crop, good control of the flow of harvested crop can be achieved by means of the control element which is introducible or movable in below the rotor since the harvested crop in these operating situations is moved through the apparatus preferably in a region below the longitudinal axis.

In one refinement, the separating device extends over the entire axial length of the rotor. In a further refinement, the separating device extends over the entire axial length of the rotor and over a further axial region which adjoins the rotor in a flow direction of the harvested crop.

Furthermore, the apparatus is preferably designed as a threshing and separating apparatus. In the threshing apparatus, a high portion of the grains, for example approx. 90% of the grains, is broken off by abrasion and severed from the remaining plant constituents. The harvested crop passes from the threshing apparatus to the separating apparatus where the remaining grains are severed from the residual plant constituents. In one refinement, the separating apparatus can have what is referred to as a straw walker via which the harvested crop is conveyed further in the flow direction on account of a shaking movement. By means of the shaking movement of the straw walker, the remaining grains can be obtained from the harvested crop. In a further refinement, the separating apparatus can have at least one rotor which loosens the harvested crop by means of a rotational movement and therefore results in an additional separation of grains. In these refinements, the separating device can extend over the axial length of a rotor which is assigned to the threshing and/or separating apparatus. Alternatively, the separating device can also extend over the axial length of a plurality of rotors which are assigned to the threshing and/or separating apparatus.

In a further refinement, the control element is movable, as seen in a flow direction of the harvested crop, into a rear half of the passage region.

By means of this arrangement of the control element, the passage region can be optimally filled with harvested crop. With the aid of the positioning of the control element in the rear half of the passage region, the harvested crop accumulates from the rear end of the apparatus counter to the flow direction of the harvested crop into the apparatus. The apparatus is therefore filled with a sufficient overall mass of harvested crop such that efficient breaking off of the grains by abrasion is obtained.

In a further refinement, the control element is movable into a region which directly adjoins the throughflow region as an extension in the flow direction of the harvested crop. In other words, the control element is therefore arranged so as to be movable in directly behind the rotor.

In this refinement, the harvested crop is braked directly behind the rotor. The entire axial length of the rotor can therefore be used for backing up the harvested crop. The grain losses can be further reduced.

According to a further refinement, the separating device region has at least one passage through which the at least one control element is movable from an outer side of the separating device into the passage region and/or into the axial projection of the passage region.

For example, the control element in this refinement can be designed as a plate-like element, for example as a metal sheet. By moving, in particular radially introducing, the sheet into the passage region and/or into the axial projection of the passage region, very efficient braking of the harvested crop and therefore good regulation of the flow of harvested crop is made possible.

According to a further refinement, the separating device region has at least one basket element which has a plurality of separating openings.

The separating openings of the basket element permit the separating or removal of the grains broken off by abrasion. The basket element here can be a threshing concave which is arranged in the region of the threshing apparatus. Furthermore, the basket element can be a severing concave which is arranged in the region of the separating apparatus. Furthermore, a basket element can extend over the threshing and/or separating apparatus. Alternatively, the separating device region can also have a plurality of basket elements.

In a further refinement, the control element is movable from an outer side of the separating device through at least one of the separating openings into the passage region and/or into the axial projection of the passage region.

In this refinement, the control element is preferably designed in the manner of a comb and is introduced radially into the passage region and/or the axial projection of the passage region through a plurality of separating openings. Separating openings can therefore also be formed in the region of the control element. This increases the effective separating area of the apparatus and therefore leads to a reduced grain loss.

In a further refinement, the control element has an axial length which is smaller than an axial length of the rotor in the direction of the longitudinal axis.

The control element therefore constricts the passage region or the axial projection of the passage region only over a small axial region which corresponds to the axial length of the control element. The general radial distance between the separating device and the rotor is maintained. As a consequence, the harvesting efficiency of the apparatus can be maintained while at the same time the separating quality for the grains is increased.

In a further refinement, a plane spanned by the control element is arranged obliquely, preferably perpendicularly, to a flow direction of the harvested crop.

In other words, the control element is arranged at an angle differing from the flow direction of the harvested crop. This in turn leads to good braking of the harvested crop and effective influencing of the flow of harvested crop.

According to a further refinement, the control element is mounted in a manner movable radially between a first and a second position and, at least in the second position, projects into the passage region.

In this refinement, the control element can be arranged in the first position outside the passage region in order therefore to permit as high a flow of harvested crop as possible. Alternatively, the control element can also be arranged within the passage region in the first position, wherein, in the first position, the control element projects less far into the passage region than in the second position. The first and the second position can also form end positions for the control element, wherein the control element is movable in a stepless manner between the first and the second position.

In a further refinement, the apparatus furthermore has an adjusting unit which is designed to move the at least one control element radially.

With the aid of the adjusting unit, precise setting of the radial position of the control element is made possible. The adjusting unit can also be designed to move a plurality of control elements radially.

According to a further refinement, the adjusting unit is adjustable mechanically, hydraulically, pneumatically and/or electrically.

For example, the adjusting unit can be designed as an adjusting lever which moves the control element radially with the aid of a mechanical mechanism. Alternatively, the adjusting unit can have an actuator which is adjustable hydraulically, pneumatically and/or electrically and which, depending on the activation, brings about a radial movement of the control element.

In a further refinement, the apparatus furthermore has a control unit which is designed to control the adjusting unit.

In this refinement, the control unit is coupled, for example electrically, to the actuator. The control unit can control the actuator such that the control element is moved radially, for example, between the first and second position. Furthermore, the control unit can have an input unit into which values which influence the radial positioning of the control element are input by an operator of the apparatus.

According to a further refinement, the apparatus furthermore has a sensing unit which is designed to sense at least one operating parameter of the apparatus, wherein the control unit is designed to move the control element radially by means of the adjusting unit depending on the operating parameter.

The sensing unit can be designed to sense an operating parameter of the apparatus and/or of a combine harvester in which the apparatus is installed. The sensing unit can be coupled electrically to the control unit and is designed to make the sensed operating parameter available to the control unit. The control unit can be designed to evaluate the provided operating parameter and to control the actuator depending on the operating parameter such that the control element is introduced radially into the passage region and/or the axial projection of the passage region.

Particularly preferably, the operating parameter comprises a grain loss and/or a load of a drive machine which is designed to operate the apparatus.

The drive machine can be, for example, a drive motor of a combine harvester in which the apparatus is integrated. If the motor load of the combine harvester is low (for example when turning at the end of the field), the control element is introduced further radially into the passage region in order to reduce the speed of the flow of harvested crop and consequently to increase the overall mass of the harvested crop located in the apparatus. As a result thereof, a reduced grain loss arises.

In a further refinement, the apparatus has a plurality of control elements which are movable into the passage region and/or into the axial projection of the passage region, and wherein the control elements are arranged at predefined axial distances from one another along the longitudinal axis.

In this refinement, the apparatus can have just one adjusting unit which is designed to move all of the control elements radially. All of the control elements here are preferably moved radially by the same amount. Alternatively, the apparatus in this refinement can have a plurality of adjusting units, wherein each of the adjusting units is assigned a control element. The individual control elements can therefore be introduced radially to differing extents into the passage region and/or into an axial projection of the passage region, said axial projection being formed along the longitudinal axis. The axial distances between the individual control elements can have the same value or different values.

According to a further refinement, the apparatus is of the axial flow type.

In the case of the axial flow type, the harvested crop is guided axially between the rotor and the separating device. In addition, the harvested crop to be processed is supplied to the apparatus in the direction of the longitudinal axis/axis of rotation of the rotor. Alternatively, the apparatus can have a tangential threshing mechanism. In this refinement, the threshing mechanism is arranged in the combine harvester transversely with respect to a working direction thereof. The harvested crop to be processed is therefore supplied to the threshing mechanism at a 90° angle to the longitudinal axis/axis of rotation of the threshing drum.

In the case of the method according to the application, it is particularly preferred if the radial introducing or the moving in of the at least one control element comprises the following steps: sensing at least one operating parameter of the apparatus, and radially moving the at least one control element depending on the operating parameter.

In this refinement, the radial position of the control element is set precisely depending on a sensed operating situation or a sensed operating parameter. Accordingly, the flow of harvested crop can be optimally adapted to the respective operating situation (for example turning of the combine harvester at the end of the field, harvested crop with a high grain portion, weather conditions, etc.). This results in a low grain loss.

It goes without saying that the features mentioned above and those which have yet to be explained below are usable not only in the respectively stated combination, but also in different combinations or on their own without departing from the scope of the present invention.

Furthermore, it goes without saying that the features, properties and advantages of the apparatus according to the application are also correspondingly relevant or applicable to the method according to the application.

### BRIEF DESCRIPTION OF THE SEVERAL VIEWS OF THE DRAWING

Exemplary embodiments are illustrated in the drawing and are explained in more detail in the description below. In the drawing:

FIG. 1 shows a schematic illustration of a combine harvester with an apparatus for processing harvested crop;

FIG. 2 shows a schematic axial sectional view of an embodiment of the apparatus;

FIG. 3 shows a schematic radial sectional view of the embodiment shown in FIG. 2 of the apparatus;

FIG. 4 shows a schematic perspective illustration of a further embodiment of the apparatus; and

FIG. 5 shows a schematic perspective illustration of a further embodiment of the apparatus.

### DETAILED DESCRIPTION

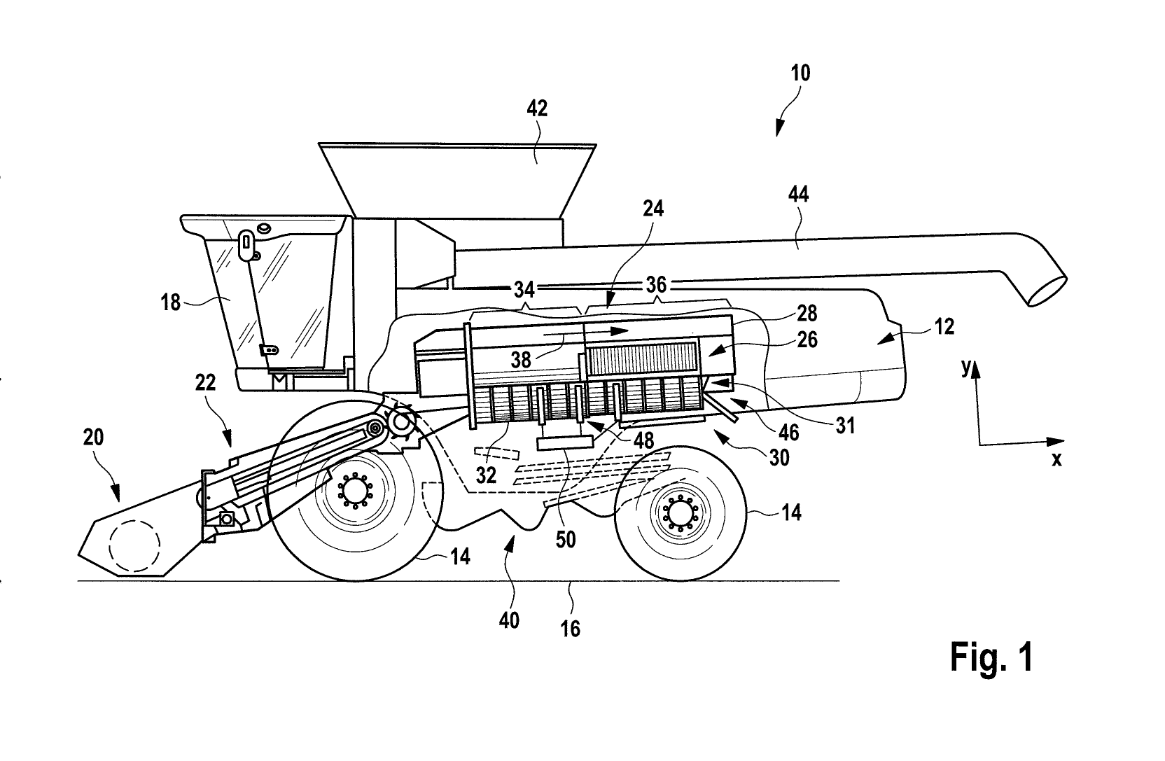

In FIG. 1, the combine harvester is denoted in general by 10.

The combine harvester 10 has a supporting structure 12 and wheels 14 which are in engagement with an underlying surface 16. Furthermore, the combine harvester 10 has a driver's cab 18 from which a driver operates the combine harvester 10. A cutting mechanism 20 of the combine harvester 10 is used to harvest harvested crop containing grain and to supply the harvested crop to an inclined conveyor 22. The harvested material is supplied to an apparatus 24 with the aid of the inclined conveyor 22. In the present exemplary embodiment, the apparatus 24 forms a threshing and separating apparatus which serves to sever the grain from the remaining plant constituents of the harvested crop. The apparatus 24 here has a rotor 26 and a separating device 28 which surrounds the rotor 26 at a radial distance. In particular, the separating device 28 has a separating device region 30 which at least partially surrounds a lower circumferential region 31 of the rotor 26. Basket elements 32 which permit separation from grains broken off by abrasion are arranged in the separating device region 30.

Various processing elements are formed on the rotor 26, and therefore the apparatus 24 has at least one threshing portion 34 and a separating portion 36. For example, in the threshing portion, the rotor 26 can have a plurality of threshing tines and, in the separating portion, can have a plurality of severing fingers. The grain is broken off from the harvested crop by abrasion by means of the threshing tines. The threshed harvested crop is subsequently loosened with the aid of the severing fingers, and therefore separation of the remaining grains is made possible.

Furthermore, the rotor 26 can have what is referred to as a conveying worm which is formed on the outer circumference of the rotor 26 and serves to convey the harvested crop in a flow direction 38 through the apparatus 24.

Grain and chaff which fall through the basket elements 32 are supplied to a cleaning device 40. The cleaning device 40 has, for example, a blower and a plurality of lamella sifters which can be set into an oscillatory motion. With the aid of the cleaning device 40, the chaff is removed and the clean grain is supplied to what is referred to as an elevator (not shown in FIG. 1). The elevator conveys the clean grain into a grain tank 42. The grain can subsequently be discharged from the grain tank 42 to a grain wagon or trailer via a discharge worm conveyor 44.

The remaining plant constituents leave the apparatus 24 through an outlet 46 and are ejected on a rear side of the combine harvester 10, for example onto the underlying surface 16.

To control the flow of harvested crop through the apparatus 24, the apparatus 24 furthermore has a plurality of control elements 48 which are introducible or movable, in particular movable radially (see y direction in FIG. 1) into an intermediate space not shown in FIG. 1 between the separating device 28 and the lower circumferential region 31 of the rotor 26. It goes without saying that it is also possible for only an individual control element 48 to be arranged on the separating device region 30 without departing from the scope of the invention. Furthermore, the apparatus 24 has an adjusting unit 50 which is designed to move the control elements 48 radially, as seen from the rotor 26. The adjusting unit 50 here can be adjustable mechanically, hydraulically, pneumatically and/or electrically.

By introducing or moving the control elements 48 into the intermediate space between the separating device 28 and the lower circumferential region 31 of the rotor 26, the harvested crop can be braked during passage through the apparatus 24. The harvested crop therefore remains in the apparatus 24 for a longer period of time. As a consequence, the grains can be more effectively broken off from the harvested crop by abrasion and separated. In particular in the case of harvested crops with a high grain portion and low amount of other plant constituents, the grain losses can be considerably reduced with this measure.

In the following figures, further embodiments of the apparatus 24 are shown. These embodiments correspond in respect of construction and manner of operation in general to the apparatus 24 from FIG. 1. Identical elements are therefore identified by the same reference signs. Essentially the differences are explained below.

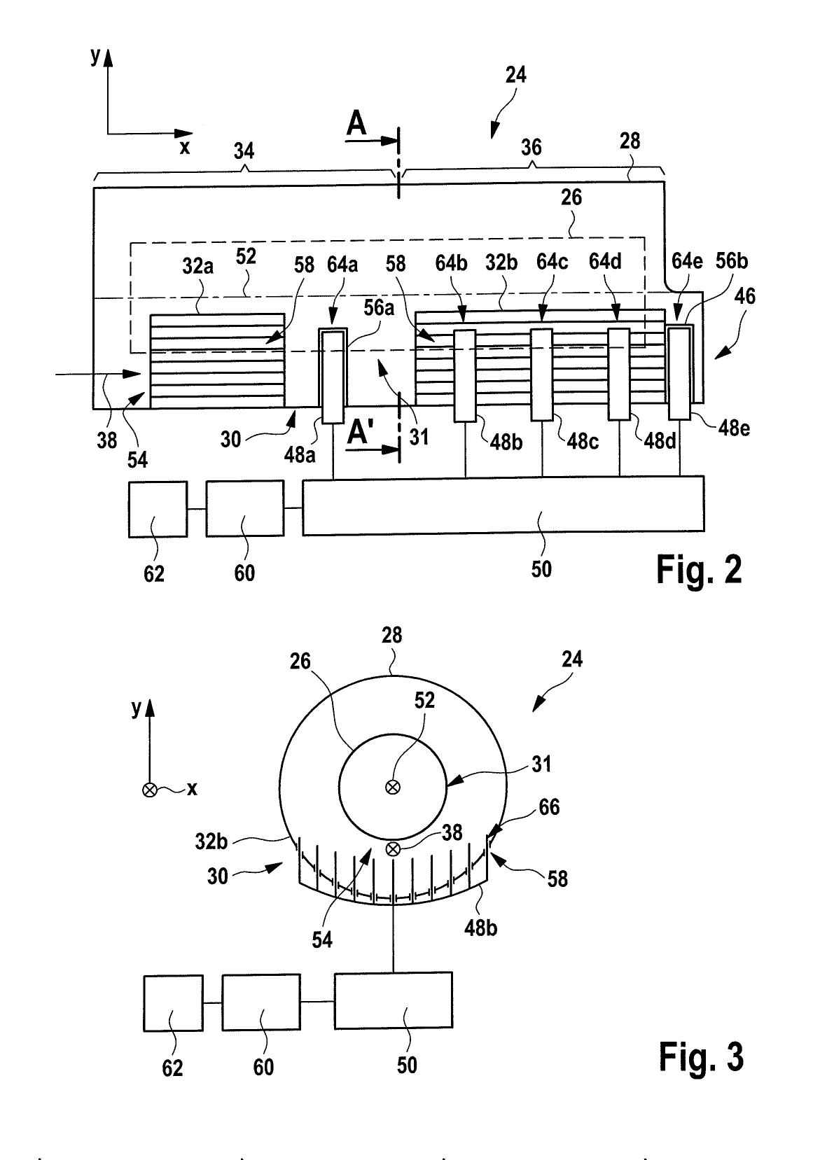

FIG. 2 shows a schematic axial sectional view (i.e. a section along the x axis) of an embodiment of the apparatus 24. The rotor 26 has a longitudinal axis 52 and is mounted rotatably about the longitudinal axis 52. The separating device region 30 surrounds the lower circumferential region 31 of the rotor 26, which circumferential region is arranged below the longitudinal axis 52 in an operationally ready state of the apparatus 24. Operationally ready state is defined here as a state in which the apparatus 24 is installed in the combine harvester 10. The separating device region 30 has, in the threshing portion 30, the basket element 32a which may also be referred to as the threshing concave element. Furthermore, the separating device region 30 has, in the separating portion 36, the basket element 32b which may be referred to as severing concave element. A passage region 54 for the harvested crop is formed between the separating device region 30 and the lower circumferential region 31 of the rotor 26.

Furthermore, the apparatus 24 in this embodiment has a plurality of control elements 48a to 48e. It goes without saying that the apparatus 24 can also have any other number of control elements 48. Furthermore, the control elements 48 can also be arranged at different axial distances from one another. In the present case, the control element 48a is arranged on the separating device region 30 within the threshing portion 34. The separating device region 30 here has a passage 56a through which the control element 48a is movable from an outer side of the separating device 28 into the passage region 54. For example, the control element 48a can be designed as a metal plate which can be introduced into the passage region 54 by means of the adjusting unit 50.

The control elements 48b, 48c, 48d are arranged within the separating portion 36 on the separating device region 30 and are of comb-like design in this exemplary embodiment. The control elements 48b to 48d can therefore be introduced radially into the passage region 54 through separating openings 58 of the basket element 32b.

The separating device region 30 has a further passage 56b which is arranged behind the rotor 26, as seen in the flow direction 38. The control element 48e is movable through the passage 56b into an axial projection of the passage region 54, said axial projection being formed along the longitudinal axis 52.

In the present embodiment, the adjusting unit 50 is designed to move all of the control elements 48a to 48e synchronously. In other words, the control elements 48a to 48e are moved radially by the same amount. In an alternative embodiment, the adjusting unit 50 can also be designed to move the control elements 48a to 48e radially independently of one another. In particular, the adjusting unit 50 in this embodiment can also have individual adjusting elements which are each assigned to one control element 48a to 48e.

In the present case, the adjusting unit 50 is controlled by a control unit 60. For example, the adjusting unit 50 can have an electric motor which is controlled electrically by the control unit 60. Depending on a control signal from the control unit 60, the electric motor acts on the control elements 48a to 48e and moves them radially into the passage region 54 and/or into the axial projection of the passage region 54.

Furthermore, the apparatus 24 has a sensing unit 62 which is designed to sense at least one operating parameter of the apparatus 24 and/or of the combine harvester 10. For example, the sensing unit 62 can have structure-borne-sound microphones which are designed to sense a grain loss. Furthermore, the sensing unit 62 can be coupled to a controller of the combine harvester 10 in order to sense a motor load of the combine harvester 10. The sensed operating parameters are made available to the control unit 60 which activates the adjusting unit 50 depending on the operating parameters in order to radially move the control elements 48a to 48e.

If, during the operation of the apparatus 24, for example a high grain loss is sensed by the sensing unit 62, the control unit 60 moves the control elements 48a to 48e further into the passage region 54 and/or into the axial projection of the passage region 54 by means of the adjusting unit 50. The control elements 48a to 48e therefore constrict the passage region 54 or the axial projection of the passage region 54 at a plurality of constriction points 64. The constriction points 64 each have a length which corresponds to an axial length of the respective control elements 48a to 48e. As a consequence, the passage region 54 or the axial projection of the passage region 54 is constricted only at the predetermined constriction points 64. However, the general radial distance between the separating device 28 and the rotor 26 is retained. This firstly makes it possible for the grain losses to be able to be reduced since the harvested crop is braked with the aid of the control elements 48a to 48e and therefore resides for longer in the apparatus 24. Secondly, by retaining the general radial distance between the separating device 28 and the rotor 26, high harvesting efficiency of the apparatus 24 or of the combine harvester 10 can be provided.

Furthermore, the sensing unit 62 can sense, for example, a reduced motor load of the combine harvester 10. In this operating situation, the combine harvester 10 is turned round, for example at the end of a field. On account of the turning-round operation of the combine harvester 10, relatively little harvested crop is located within the apparatus 24. The overall mass of the harvested crop present in the apparatus 24 therefore does not suffice to effectively break off the grains by friction. According to the design, the control elements 48a to 48e are therefore introduced further into the passage region 54 or into the axial projection of the passage region 54 in order to increase the overall mass of the harvested crop located in the apparatus 24. The grain losses can be reduced by this measure.

If a high motor load of the combine harvester 10 is again sensed by means of the sensing unit 62, the control elements 48a to 48e are moved radially in such a manner that the control elements 48a to 48e project less far into the passage region 54 and/or into the axial projection of the passage region 54. Furthermore, the control elements 48a to 48e can also be pulled completely out of the passage region 54 and/or of the axial projection of the passage region 54.

FIG. 3 shows a schematic radial sectional view of the embodiment shown in FIG. 2 of the apparatus 24 along the intersecting line A-A′ (i.e. a section along the y axis).

It can be gathered from this view that the control element 48b is of comb-like design, wherein individual tines 66 of the control element 48b project into the passage region 54 through a plurality of separating openings 58 of the basket element 32b. In the exemplary embodiment illustrated in FIG. 3, a plane formed by the tines 66 is arranged perpendicularly to the flow direction 38 of the harvested crop. However, it goes without saying that the plane formed by the tines 66 can also be arranged at any other angle obliquely with respect to the flow direction 38. Furthermore, the flow direction 38 can also run, for example, helically around the longitudinal axis 52 depending on a surface configuration of the rotor 26. Also in this embodiment, the control elements 48 are arranged in such a manner that the planes spanned by the control elements 48 are arranged obliquely, preferably perpendicularly, with respect to the flow direction 38.

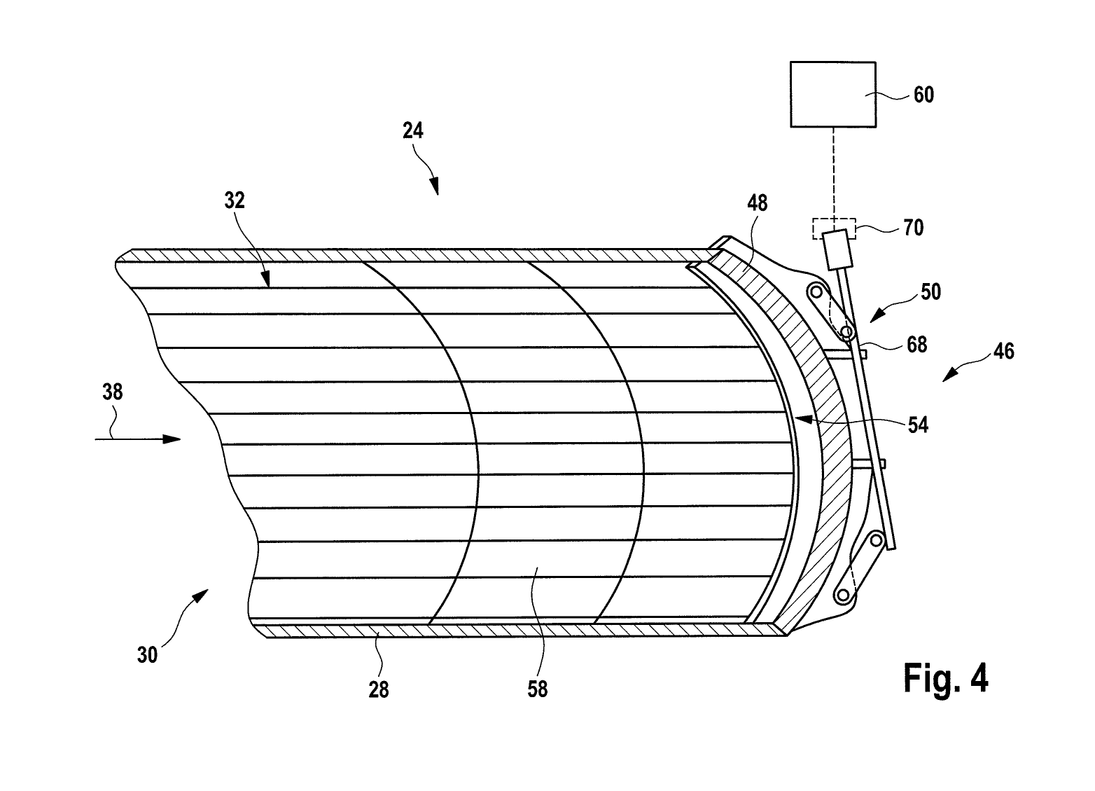

FIG. 4 shows a schematic perspective illustration of a further embodiment of the apparatus 24. In particular, FIG. 4 shows the apparatus 24 from a viewing angle below the apparatus 24.

In this embodiment, the apparatus 24 has just one control element 48 which is movable directly behind the rotor or basket element 32, as seen in the flow direction 38, into the axial projection of the passage region 54. In this embodiment, the adjusting unit 50 has a mechanical adjustment mechanism 68 which is illustrated in schematic form in FIG. 4. For example, the mechanical adjustment mechanism 68 can be actuated by the driver of the combine harvester 10. The control element 48 can be introduced further into the axial projection of the passage region 54, for example by rotation of the mechanical adjustment mechanism 68, in order to more greatly brake the flow of harvested crop. By corresponding actuation of the mechanical adjustment mechanism 68, the control element 48 can also be moved again out of the axial projection of the passage region 54 in order to increase the flow of harvested crop.

The adjusting unit 50 can optionally also have a hydraulic, pneumatic or electric actuator 70 which is controlled via the control unit 60 in order to move the control element 48 radially.

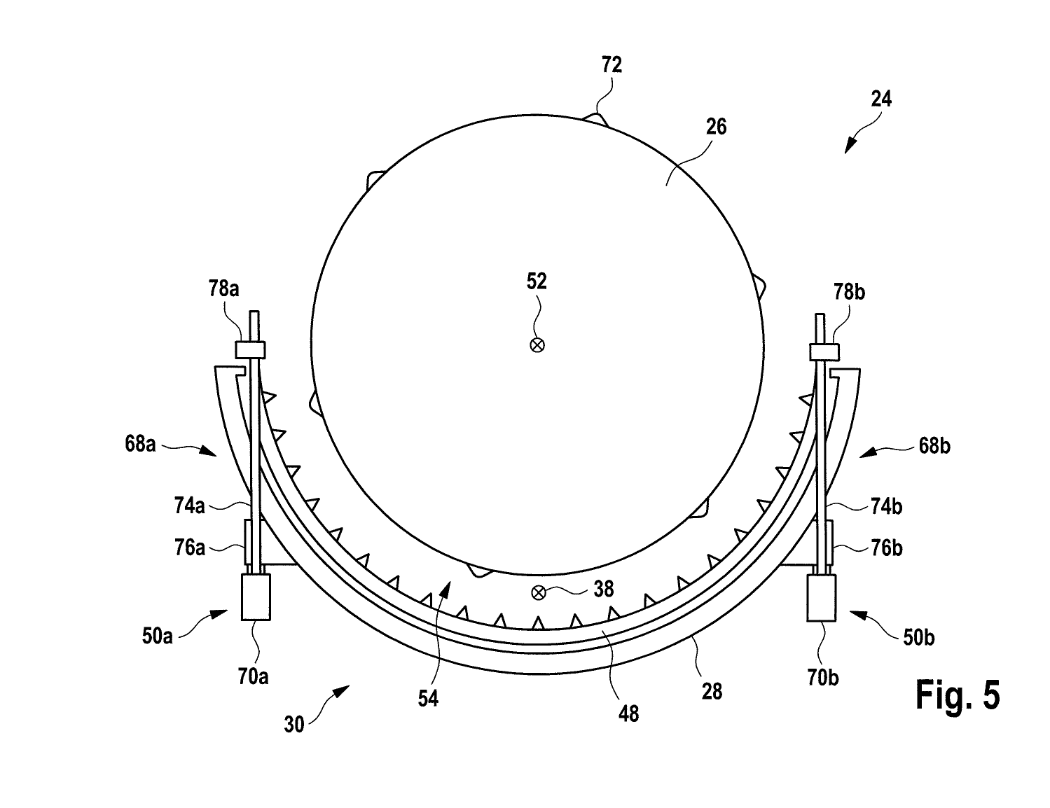

FIG. 5 shows a schematic perspective illustration of a further embodiment of the apparatus 24. In particular, FIG. 5 shows the apparatus 24 from a viewing angle in the direction of the longitudinal axis 52.

It is shown in more detail in this embodiment that the rotor 26 is equipped on its outer circumference with what are referred to as beater bars 72. The harvested crop can be very efficiently broken off by abrasion with the aid of the beater bars 72 if the rotor 26 is set into a rotational movement.

In addition, it is shown in FIG. 5 that the apparatus 24 has two adjustment mechanisms 68a, 68b which are designed to introduce the control element 48 radially into the passage region 54 or to move the control element 48 radially within the passage region 54. The adjustment mechanisms 68a, 68b here are assigned the actuators 70a, 70b which are designed as servomotors.

Each of the adjustment mechanisms 68a, 68b can have an adjustment spindle 74 which is connected to the actuator 70, and which can be set into a rotational movement by the actuator 70. The adjustment spindle 74 is guided here by a first holder 76 and a second holder 78 which is designed as a threaded holder.

If the adjustment spindle 74 is set into a rotational movement with the aid of the assigned actuator 70, the control element 48 is moved radially within the passage region 54 because of the mounting of the adjustment spindle 74 in the threaded holder 78.

The two actuators 70a, 70b are preferably controlled in such a manner that the control element 48 is moved uniformly with respect to the two holders 78a, 78b. However, there is also the possibility of activating the two actuators 70a, 70b differently in order to differently raise or lower the control element 48 with respect to the two holders 78a, 78b.

Although preferred embodiments of the apparatus 24 and of the method have therefore been shown, it goes without saying that various modifications can be made without departing from the scope of the invention.

For example the control elements 48 can also be used in what is referred to as a tangential threshing mechanism. Furthermore, any desired adjustment mechanisms can be used for moving the control elements 48.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An apparatus for processing harvested crops, comprising:
a rotor which is mounted rotatably about its longitudinal axis,
a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, wherein the separating device region extends along the longitudinal axis, at least in a partial region of the rotor, and
at least one control elements which is arranged on the separating device region, wherein the at least one control element is movable into the passage region and/or into an axial projection of the passage region, said axial projection being formed along the longitudinal axis, in order to control the flow of harvested crop.

2. The apparatus as claimed in claim 1, wherein the control element is movable, as seen in a flow direction of the harvested crop, into a rear half of the passage region.

3. The apparatus as claimed in claim 1, wherein the separating device region has at least one passage through which the at least one control element is movable from an outer side of the separating device into the passage region and/or into the axial projection of the passage region.

4. The apparatus as claimed in claim 1, wherein the separating device region has at least one basket element which has a plurality of separating openings.

5. The apparatus as claimed in claim 4, wherein the control element is movable from an outer side of the separating device through at least one of the separating openings into the passage region and/or into the axial projection of the passage region.

6. The apparatus as claimed in claim 1, wherein the control element has an axial length which is smaller than an axial length of the rotor in the direction of the longitudinal axis.

7. The apparatus as claimed in claim 1, wherein a plane spanned by the control element is arranged obliquely to a flow direction of the harvested crop.

8. The apparatus as claimed in claim 1, wherein the control element is mounted in a manner movable radially between a first and a second position and, at least in the second position, projects into the passage region.

9. The apparatus as claimed in claim 1, wherein the apparatus furthermore has an adjusting unit which is designed to move the at least one control element radially.

10. The apparatus as claimed in claim 9, wherein the adjusting unit is adjustable mechanically, hydraulically, pneumatically and/or electrically.

11. The apparatus as claimed in claim 9, wherein the apparatus furthermore has a control unit which is designed to control the adjusting unit.

12. The apparatus as claimed in claim 11, wherein the apparatus furthermore has a sensing unit which is designed to sense at least one operating parameter of the apparatus, wherein the control unit is designed to move the control element radially by means of the adjusting unit depending on the operating parameter.

13. The apparatus as claimed in claim 12, wherein the operating parameter comprises a grain loss and/or a load of a drive machine which is designed to operate the apparatus.

14. The apparatus as claimed in claim 1, wherein the apparatus has a plurality of control elements which are movable into the passage region and/or into the axial projection of the passage region, and wherein the control elements are arranged at predefined axial distances from one another along the longitudinal axis.

15. The apparatus as claimed in claim 1, wherein the apparatus is of the axial flow type.

16. A combine harvester with an apparatus as claimed in claim 1.

17. A method for controlling the flow of a harvested crop in an apparatus for processing harvested crops, wherein the apparatus comprises a rotor which is mounted rotatably about its longitudinal axis, a separating device with a separating device region which at least partially surrounds a lower circumferential region of the rotor, said circumferential region being arranged below the longitudinal axis in an operationally ready state of the apparatus, and is arranged radially spaced apart from the rotor, wherein a passage region for the harvested crop is formed between the separating device region and the lower circumferential region of the rotor, wherein the separating device region extends along the longitudinal axis, at least in a partial region of the rotor, and has at least one control element which is arranged on the separating device region, wherein the method comprises:
moving the at least one control element into the passage region and/or into an axial projection of the passage region, said axial projection being formed along the longitudinal axis, in order to control the flow of harvested crop.

18. The method as claimed in claim 17, wherein the moving in of the at least one control element further comprises the following steps:
sensing at least one operating parameter of the apparatus, and
radially moving the at least one control element depending on the operating parameter.

19. The apparatus as claimed in claim 1, wherein the apparatus is a threshing and/or separating apparatus.

20. The apparatus of claim 7, wherein a plane spanned by the control element is arranged perpendicularly to a flow direction of the harvested crop.

21. The method as claimed in claim 17, wherein the apparatus is a threshing and/or separating apparatus.
